(19) United States
(12) Patent Application Publication
(10) Pub. No.: US 2019/0368789 A1
(43) Pub. Date: Dec. 5, 2019

(54) PULSED LIQUID CRYOGEN FLOW GENERATOR

(71) Applicant: Michael D. Newman, Hillsborough, NJ (US)

(72) Inventor: Michael D. Newman, Hillsborough, NJ (US)

(21) Appl. No.: 16/541,903

(22) Filed: Aug. 15, 2019

Related U.S. Application Data
(63) Continuation of application No. 14/816,098, filed on Aug. 3, 2015.

(51) Int. Cl. F25B 41/04; A23L 3/375; F25B 19/00; F25B 43/00

(52) U.S. Cl. CPC F25B 41/04; F25B 43/00; F25B 19/005; A23L 3/375

(57) ABSTRACT

An apparatus for providing a liquid cryogen with pulsed flow includes a first tank 14 containing liquid cryogen; a second tank 16 containing gaseous cryogen under pressure, the second tank in fluid communication with the first tank and including an outlet; and a pair of valves including a first valve 70 disposed to alternate between interruption and continuance of the fluid communication between the first and second tanks, and a second valve 74 disposed for coaction up to 180° out-of-phase with the first valve to repetitively cycle between pressurizing and releasing pressure of the liquid cryogen for providing discrete pulses of the liquid cryogen from the outlet. A related method is also provided.

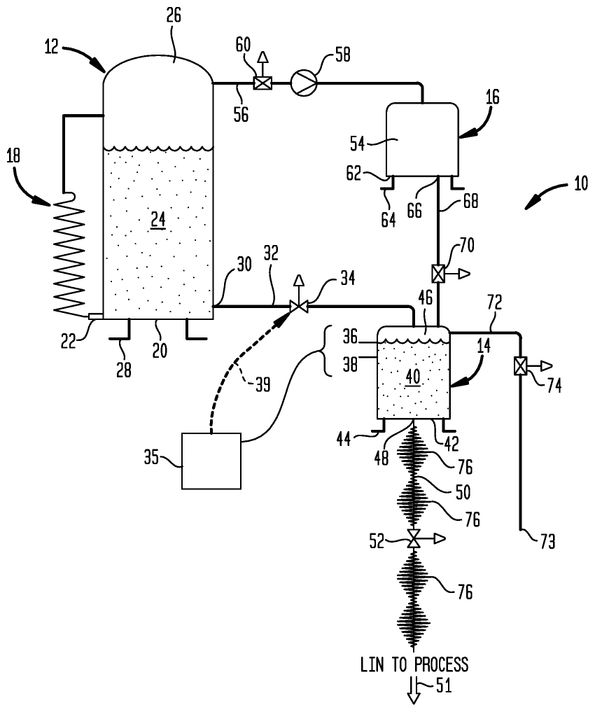

### BACKGROUND OF THE INVENTION

The present embodiments relate to food freezer tunnel apparatus for cryogenically chilling for example food products, and related processes therefore.

Food freezing tunnels, such as for example those that use cryogenic substances to chill and/or freeze food products, are limited in their capacity by the overall heat transfer co-efficient that can be used on the products. For example, many food freezing tunnels rely upon increasing heat transfer effect by correspondingly increasing air flow velocity across the product for which the heat transfer is to be applied. There are unfortunately, practical and economic limitations in many of these apparatus and methods and therefore, the increased heat transfer effect is not fully realized, especially with and during large scale industrial operations.

The food processing industry would benefit from increased heat transfer effect with food freezing applications, because greater heat transfer effect results in being able to use smaller apparatus or conversely, using apparatus which can increase the production or flow through rate of products to be chilled or frozen.

Some improvements are known and being used in food freezing tunnels. For example, spray nozzles are now used to increase the overall heat transfer effect during the freezing process by spraying liquid nitrogen (LIN) through the nozzles directly onto the surface of the food product to contact same with droplets of that cryogenic substance. These small nitrogen droplets evaporate quickly upon contact with the food product, thereby removing or transferring heat immediately from the surface of the food product to chill and further freeze same.

Other apparatus and systems use high pressure LIN to provide heat transfer at the surface of the food product.

Unfortunately, these known apparatus and processes are expensive, can result in an unusually large amount of the nitrogen product being lost to waste or alternatively, require additional equipment to recycle unused nitrogen. In both instances, increased costs and a larger footprint of the food freezing tunnel are necessary, thereby making the known type of apparatus and processes less efficient and less cost-effective.

### SUMMARY OF THE INVENTION

There is therefore provided a generator apparatus embodiment for providing a pulsed flow of liquid cryogen which includes a first tank containing a first portion of liquid cryogen; a second tank containing a second portion of liquid cryogen, the second tank in fluid communication with the first tank and having an outlet; a third tank containing gaseous cryogen under pressure, the third tank in fluid communication with the first and second tanks; and a pair of valves consisting of a first valve disposed to alternate between interrupting and providing fluid communication between the second and third tanks, and a second valve constructed and arranged to coact 180° out-of-phase with the first valve and disposed to alternate between pressurizing and releasing pressure of the second portion of the liquid cryogen for providing discrete pulses of liquid cryogen from the outlet.

There is also provided an apparatus embodiment for providing liquid cryogen with a pulsed flow including a first tank containing liquid cryogen; a second tank containing gaseous cryogen under pressure, the second tank in fluid communication with the first tank and including an outlet; and a pair of valves including a first valve disposed to alternate between interruption and continuance of the fluid communication between the first and second tanks, and a second valve disposed for coaction up to 180° out-of-phase with the first valve to repetitively cycle between pressurizing and releasing pressure of the liquid cryogen for providing discrete pulses of said liquid cryogen from the outlet.

Another embodiment of the apparatus calls for the first and second valves to coact 180° out-of-phase with each other.

There is also provided a method embodiment of providing liquid cryogen with a pulsed flow including providing a first tank containing liquid cryogen therein; providing a second tank containing gaseous cryogen therein, the second tank in fluid communication with the first tank; and repetitively pressurizing the first tank with the gaseous cryogen from the second tank and releasing the pressure for correspondingly forcing discrete pulses of the liquid cryogen to be released from the first tank.

There is also provided another method embodiment of providing liquid cryogen with a pulsed flow including containing an amount of liquid cryogen; containing an amount of gaseous cryogen under pressure; providing fluid communication between the liquid cryogen and the gaseous cryogen; and repetitively interrupting and continuing the fluid communication of the pressurized gaseous cryogen to contact the liquid cryogen for generating the pulsed flow of liquid cryogen.

Other features of the present apparatus and method embodiments are described hereinafter.

### BRIEF DESCRIPTION OF THE DRAWING

For a more complete understanding of the present invention, reference may be had to the following description of exemplary embodiments considered in connection with the accompanying drawing FIGURE, which shows a pulsed liquid cryogen flow generator apparatus to be used with for example food products.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

Generally, a pulsed liquid cryogen flow generator apparatus of the present embodiments produces small droplets of a cryogenic substance, such as for example LIN, in combination with high pressure pulses of the LIN to provide high heat transfer rates for products, such as for example food products. The result is that an impingement heat transfer effect is created by cryogen beneath a spray nozzle for the apparatus. Additionally, if the LIN is in a saturated range while a liquid pressure wave pulse is introduced, some nitrogen gas could be created in the flow stream as a result of rapid pressure change. This may occur because the saturated LIN is at its thermodynamic state of liquid nitrogen in vapor—liquid equlibrium or at its boiling point, whereby it exists as a pure liquid at this stage, but can either vaporize a subcool in response to changes in pressure or temperature. Accordingly, the degree or range of pressure fluctuation will have an impact on the degree of a two-phase flow passing through nozzle(s) of the apparatus, and can be used as a method of controlling the discharge of the pulsed LIN from the nozzle(s).

A pulsed liquid cryogen flow generator apparatus of the present embodiments is shown generally at 10. As used herein, the apparatus 10 may also be referred to as a “generator” or a “generator apparatus”. Cryogens that can be used in the generator are, for example, LIN or CO₂ liquid, although pulsing of C0₂ would require control parameters having to be limited due to the triple point of CO₂.

For the purpose of the description herein and by way of example only, the cryogen referred to will be nitrogen, whether LIN or gaseous nitrogen.

The apparatus 10 includes a plurality of tanks 12, 14, 16 or vessels. The tank 12 is a liquid nitrogen (LIN) bulk tank, vertically arranged by way of example only, and includes a pressure control vaporizer 18 of conventional construction and operatively associated with the tank. A bottom 20 of tank 12 is provided with an outlet 22, such as for example a spigot, which is in fluid communication with one end of the vaporizer 18 and through which LIN 24 in the tank can be passed to phase change into gaseous nitrogen and be introduced at an opposite end of the vaporizer into a headspace 26 or ullage of the tank 12. The pressure in the tank 12 is maintained at approximately 30 psig. Supports 28 or footings, adjustable or fixed, support the tank 12 off an underlying surface. The tank 12 may also be referred to herein as the “bulk tank” or the “main tank”.

There is also provided at the bottom 20 of the tank 12 an outlet 30 in fluid communication with a pipe 32 having an opposed end in fluid communication with the tank 14 which has a smaller volume than the tank 12. The tank 14 may be referred to as the “secondary” or “ancillary” tank. A control valve 34 is interposed in the pipe 32 for a purpose to be described hereinafter. The tank 14 receives a stream of the LIN 24 from the tank 12 via the pipe 32, wherein a substantially constant volume of LIN 40 is maintained in the tank 14.

To accomplish this, level probes 36,38 are installed in the tank 14 to sense a maximum height of the LIN 40 in the tank (probe 36) and a minimum level of the LIN in the tank (probe 38). The level probes 36, 38 transmit respective signals to a controller 39 which is connected to the control valve 34 via wiring 39 to accordingly respond to the signals transmitted by the probes to determine what additional amount of the LIN 24 must be permitted to flow through the pipe 32 into the tank 14. Any known arrangement of probes 36,38, valving 34 and controller 35 coacting to maintain a fluid level of the LIN 40 in the tank 14 can be used. The amount of the LIN 40 in the tank 14 is therefore maintained at a level not to exceed a probe capacitance at 36 or be less than a probe capacitance at 38.

A bottom 42 of the tank 14 is supported off an underlying surface with supports 44 or footings, adjustable or fixed. A headspace 46 or ullage of the tank 14 is present above the LIN 40 and into which the LIN 24 flows from the pipe 32. That is, the headspace 46 of the tank 14 is in fluid communication with the LIN 24 in the tank 12. The bottom 42 of the tank 14 also includes an outlet 48 in fluid communication with an exhaust 50 which functions as the injection pipe for the apparatus 10. The LIN 40 in the tank 14 flows through the injection pipe 50 for application processes and/or to nozzles 51 downstream of the tank 14 and in a manner to be described hereinafter. The injection pipe 50 also includes a control valve 52 or gate valve.

The tank 16 is constructed and arranged to hold a volume of high pressure nitrogen (N₂) gas 54. The tank 16 may also be referred to herein as the “pressurizing tank” or the “gas tank”, and such gas is provided from the main tank 12. That is, gaseous nitrogen from the headspace 26 of the tank 12 is withdrawn through a pipe 56 in fluid communication with the head space and provided to the pressure tank 16. The gas is removed from the head space 26 along the pipe 56 by a pressure pump 58 interposed in the pipe 56. The pressure pump 58 increases the pressure of the gas from approximately 30 psig in the tank 12 up to 200 psig within the tank 16. A gate valve 60 is also provided in the pipe 56 to control the flow of the gas from the head space 26 to the pressure pump 58. The tank 16 includes a bottom 62 from which supports 64 or legs, adjustable or fixed, extend to support the tank 16 off an underlying surface. The bottom 62 is provided with an outlet 66 which is in fluid communication with pipe 68. The pipe 68 functions as a gas line in fluid communication with the headspace 46 of the secondary tank 14. A high speed valve 70 is interposed in the gas line 68 to control the flow of the gas 54 from the tank 16 to the head space 46 of the secondary tank 14, and to also control a pressure pulsation rate of the gas as explained below.

A nitrogen gas vent line 72 or pipe has one end in fluid communication with the headspace 46 of the secondary tank 14 and an opposite end in fluid communication with an outlet 73 to atmosphere or subsequent application process. Another high speed valve 74 is interposed in the vent line 72 upstream of the outlet 73. The high speed valves 70, 74 will operate 180 degrees out-of-phase with each other during operation of the apparatus 10. That is, when valve 70 is open, valve 74 will be closed, and vice versa.

Operation of the apparatus 10 is as follows. The secondary or ancillary tank 14 is filled with the LIN 40 to the higher level indicated by the level probe 36 or sensor. The LIN 40 in the tank 14 is obtained from the pipeline 32 which is in fluid communication with the LIN 24 in the main tank 12. At this time in the process, pressure in the tank 14 is 30 psig, and the LIN 40 discharged from the outlet 48 and through the injection pipe 50, and the nozzles 51 if used, is flowing into the freezing process at 30 psig to contact food products (not shown), for example. Nitrogen gas is present in the gas tank 16 up to a pressure of as much as 200 psig, for example, as provided by the pump 58. The pump draws gaseous nitrogen from the headspace 26 through the pipe 56 to the tank 16.

Valve 70 is actuated to an open position, while valve 74 is actuated to a closed position. The corresponding pressure which results from introducing the gaseous nitrogen from the gas tank 16 through the pipe 68 to the headspace 46 in the ancillary tank 14 is thereby increased up to 200 psig by this positioning of the valves 70, 74. The rapid opening of the valve 70 concurrent with the valve 74 being closed permits a pulse 76 of LIN to be emitted from the outlet 48 of the tank 14. This occurs because when the valve 70 is quickly opened a burst of pressurized nitrogen gas is introduced into the headspace 46 for pulsing a portion 76 of the LIN 40 from the outlet 48 to and through the nozzles 51 (if used). The valve 70 is then closed, and valve 74 is opened so that the pressure in the headspace 46 is again reduced. The pressure in the tank 16 is maintained at 200 psig by the pump 58 at which time the valve 70 is again opened and the valve 74 is closed to again emit the LIN pulse 76 from the tank 14.

The result is that a pressure pulse is generated in the flowing LIN for the process, such that the pressure increases from 30 psig to 200 psig for a short period of time, approximately 0.1-1.0 seconds. This process continues repetitively with valves 70, 74 opening and closing up to 180 degrees (180°) out-of-phase with each other as the LIN flow is forced from the tank 14 and into the injection pipe 50 as pulses 76 of LIN. Another embodiment has the valves 70, 74 opening and closing exactly (180°) out-of-phase with each other. An alternate embodiment includes having a continuous stream or flow of the LIN 40 flowing through the injection pipe 50, even as pressure in the pipe is between 30 to 200 psig during occurrence of the pulses 76. That is, the pulses 76 occur in the LIN 40 flowing through and out of the pipe 50, and the nozzle 51 if being used.

Eventually, the LIN 40 in the tank 14 will need to be replenished from the tank 12. At such time, the LIN 24 will be fed through the outlet 30 into the pipe 32 and thereafter into the tank 14 either between pulses if needed, or when the level probe 38 or sensor is triggered and transmits a signal that a refill of the LIN 40 is needed for the tank 14. At such time for replenishment, a delay in the operation process must be provided in order to implement a refill of the LIN 40 to the tank 14.

If the nature of the process of chilling the food product is such that a refill time period for the tank 14 cannot be accommodated, then a plurality of the apparatus 10 can be used so that there is never down time of the apparatus and a delay or cessation of the process. Accordingly, when a plurality of the apparatus 10 are used, at least one apparatus can be in operation, while the other apparatus is in a recharge mode. If a plurality of the apparatus 10 are used, only one additional apparatus of the plurality needs to have another one of the tanks 14, so that one tank can be in refill mode while the other tank is in operation mode, whereby the process can continue uninterrupted for as long as necessary.

As shown in the FIGURE, LIN pulses 76 pass through the injection pipe 50 to be provided to a freezing system and/or spray nozzle 51 used in food chilling and/or processing applications.

The apparatus provides the pulses 76 of LIN without any gas entrainment in the LIN pulses, such that the LIN alone contacts the food products for heat transfer at same. If saturated LIN is fed into the tank 14, however, nitrogen gas will be created in pulses having increased pressure if the pulses are exhausted from the tank. If subcooled LIN is fed into the tank 14, an upper pressure limit of the pulses could be controlled so that no nitrogen gas is created during the pulsing process.

C0₂ and liquid C0₂ can be used instead of the LIN and gaseous nitrogen, but other control equipment and parameters would be necessary to operate the apparatus 10 and related process with the C0₂.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An apparatus for providing liquid cryogen with a pulsed flow, comprising:
a first tank 12 containing a first portion of liquid cryogen therein;
a second tank 14 containing a second portion of liquid cryogen therein and including an outlet, the second tank in fluid communication with the first tank and the first portion therein;
a third tank 16 containing gaseous cryogen under pressure, the third tank in fluid communication with the first and second tanks; and
a pair of valves comprising a first valve 70 disposed to alternate between interruption and continuance of the fluid communication between the second and third tanks, and a second valve 74 disposed for coaction up to 180° out-of-phase with the first valve to provide discrete pulses of said second portion of the liquid cryogen from the outlet.

2. The apparatus of claim 1, wherein the liquid cryogen comprises liquid nitrogen (LIN), and the gaseous cryogen comprises nitrogen (N₂).

3. The apparatus of claim 1, wherein the liquid cryogen comprises liquid carbon dioxide, and the gaseous cryogen comprises carbon dioxide (C0₂).

4. The apparatus of claim 1, further comprising a nozzle disposed at the outlet and through which pass said discrete pulses of liquid cryogen.

5. The apparatus of claim 1, wherein the first tank comprises a first headspace 26 above the first portion, and the third tank is in fluid communication with the first headspace.

6. The apparatus of claim 5, wherein the second tank comprises a second headspace 46 above the second portion, and the third tank is in fluid communication with the second headspace.

7. The apparatus of claim 6, wherein the first and second valves coact 180° out-of-phase responsive to an amount and pressure of the second portion within the second tank.

8. The apparatus of claim 1, further comprising a pump coacting with the fluid communication between the first and third tanks for providing pressure to the gaseous cryogen.

9. An apparatus for providing liquid cryogen with a pulsed flow, comprising:
a first tank 14 containing liquid cryogen;
a second tank 16 containing gaseous cryogen under pressure, the second tank in fluid communication with the first tank and including an outlet; and
a pair of valves comprising a first valve 70 disposed to alternate between interruption and continuance of the fluid communication between the first and second tanks, and a second valve 74 disposed for coaction up to 180° out-of-phase with the first valve to repetitively cycle between pressurizing and releasing pressure of the liquid cryogen for providing discrete pulses of said liquid cryogen from the outlet.

10. The apparatus of claim 9, further comprising a bulk tank 12 of additional liquid cryogen therein and including a headspace 26 having additional gaseous cryogen above the additional liquid cryogen, the additional liquid cryogen in fluid communication with the first tank and the additional gaseous cryogen in the headspace in fluid communication with the second tank.

11. The apparatus of claim 10, wherein the liquid cryogen is a liquid selected from the group consisting of LIN and liquid CO₂, and the gaseous cryogen is a gas selected from the group consisting of gaseous nitrogen and CO₂.

12. The apparatus of claim 9, further comprising a first sensor and a second sensor spaced apart within an interior of the first tank, the first sensor sensing an upper limit of liquid cryogen in the first tank and the second sensor sensing a lower limit of said liquid cryogen in the first tank.

13. A method of providing liquid cryogen with a pulsed flow, comprising:
providing a first tank 14 containing liquid cryogen therein;
providing a second tank 16 containing gaseous cryogen therein, the second tank in fluid communication with the first tank; and
repetitively pressurizing the first tank with the gaseous cryogen from the second tank and releasing the pressure for correspondingly forcing discrete pulses of the liquid cryogen to be released from the first tank.

14. The method of claim 13, further comprising supplying a flow of the liquid cryogen with the discrete pulses of liquid cryogen.

15. The method of claim 13, wherein the liquid cryogen is a liquid selected from the group consisting of liquid nitrogen (LIN) and liquid CO₂, and the gaseous cryogen is a gas selected from the group consisting of nitrogen (N₂) and CO₂.

16. A method of providing liquid cryogen with a pulsed flow, comprising:
containing an amount of liquid cryogen;
containing an amount of gaseous cryogen under pressure;
providing fluid communication between the liquid cryogen and the gaseous cryogen; and
repetitively interrupting and continuing the fluid communication of the pressurized gaseous cryogen to contact the liquid cryogen for generating the pulsed flow of liquid cryogen.

17. The method of claim 16, further comprising continuing the flow of the liquid cryogen having pulses of the liquid cryogen therein.

18. The method of claim 16, wherein the liquid cryogen is a liquid selected from the group consisting of liquid nitrogen (LIN) and liquid CO₂, and the gaseous cryogen is a gas selected from the group consisting of nitrogen (N₂) and CO₂.

19. The method of claim 16, further comprising sensing an amount of liquid cryogen for determining replenishment of said liquid cryogen.
